(19) United States
(12) Patent Application Publication
(10) Pub. No.: US 2007/0249235 A1
(43) Pub. Date: Oct. 25, 2007

(54) Audio jack connector

(75) Inventor: Yin-Lung Wu, Tu-Cheng City (TW)

Correspondence Address: BIRCH STEWART KOLASCH & BIRCH, PO BOX 747, FALLS CHURCH, VA, 22040-0747, US

(73) Assignee: Cheng Uei Precision Industry Co., Ltd.

(21) Appl. No.: 11/409,969

(22) Filed: Apr. 25, 2006

(51) Int. Cl. H01R 24/04

(52) U.S. Cl. 439/668

(57) ABSTRACT

An audio jack connector includes an insulating body and a plurality of contacts. The insulating body has a main body and a mating portion integrally formed at one end of the main body. A mating hole crosses through the mating portion and extends into the main body. A plurality of contact grooves is defined in the insulating body. Each contact groove communicates with the mating hole and each contact groove communicates with outside. Each contact has a holding part, a touching part and a compression part. The holding part of the contact is held in the corresponding contact groove. The compression part extends out the insulating body. The touching part extends into the mating hole. Wherein one of the contact grooves communicates with the mating hole through the mating portion, and the touching part of the contacts extends into the mating hole through the mating portion.

### BACKGROUND OF THE INVENTION

1. Field of the Invention

The present invention relates to an electrical connector, and more particularly, to an audio jack connector.

2. The Related Art

Audio jack connector is used to mate with audio plug connector for transmitting audio signals. The audio jack connector commonly includes an insulating body and a plurality of contacts disposed in the insulating body. The insulating body includes a main portion and a mating portion formed at one end of the main portion. A mating hole crosses through the mating portion and further extends into the main portion of the insulating body. A plurality of contact grooves is defined in the insulating body. These contact grooves located at two sides of the mating hole. Each of the contact grooves communicates with the mating hole. Each contact has a touching part, a holding part and a compression part. The holding part is held in the contact groove, the touching part is located in the mating hole, and the compression part is located at the out of the insulating body.

However, in prior art, the touching parts of the contacts at any audio jack connector are located in the mating hole of the main portion. Thereby, the space of the mating hole of the main portion is crowded for receiving these touching portions of the contacts.

### SUMMARY OF THE INVENTION

Accordingly, one object of the present invention is to provide an audio jack connector, which reduces the possibility of unexpected touches between the contacts.

The electrical connector assembly includes an insulating body and a plurality of contacts. The insulating body has a main body and a mating portion integrally formed at one end of the main body. A mating hole crosses through the mating portion and extends into the main body. A plurality of contact grooves is defined in the insulating body. Each contact groove communicates with the mating hole and each contact groove communicates with outside. Each contact has a holding part, a touching part and a compression part. The holding part of the contact is held in the corresponding contact groove. The compression part extends out the insulating body. The touching part extends into the mating hole. One of the contact grooves communicates with the mating hole through the mating portion, and the touching part of the contact extends into the mating hole through the mating portion.

As mentioned above, one of the contact grooves communicates with the mating hole through the mating portion, which makes the touching part of the contact extending into the mating hole of the mating portion. Therefore, the mating hole of the main body provides a wide-enough space to receive the touching parts of other contacts. Thereby, unexpected touches among the touching parts of the contacts are reduced.

These and other features, objects and advantages of the present invention will be more fully apparent from the following detailed description base forth below when taken in conjunction with the accompanying drawings.

### BRIEF DESCRIPTION OF THE DRAWINGS

FIG. 1 is a perspective view showing an audio jack connector according to the present invention;

FIG. 2 is an exploded view showing the audio jack connector;

FIG. 3 is a perspective view of an insulating body of the audio jack connector in FIG. 2; and

FIG. 4 is a cross-sectional view of the audio jack connector showing the contacts assembled therein.

### DETAILED DESCRIPTION OF THE PREFERRED EMBODIMENT

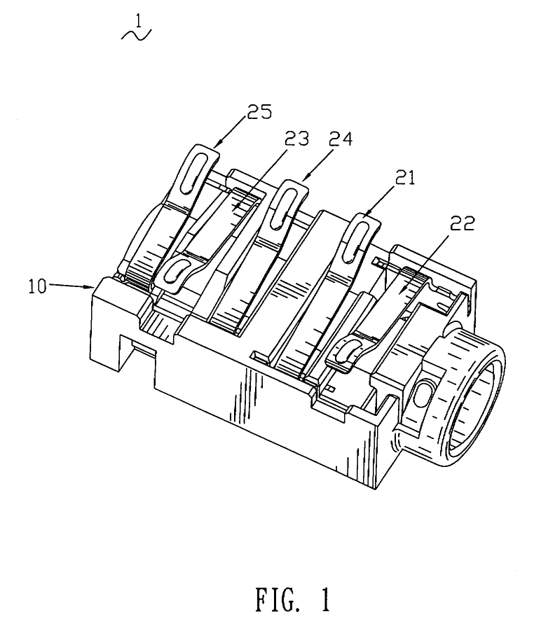

With reference to FIG. 1, an audio jack connector 1 according to the present invention is illustrated. The audio jack connector 1 includes an insulating body 10 and a plurality of contacts 21, 22, 23, 24 and 25 disposed in the insulating body 10.

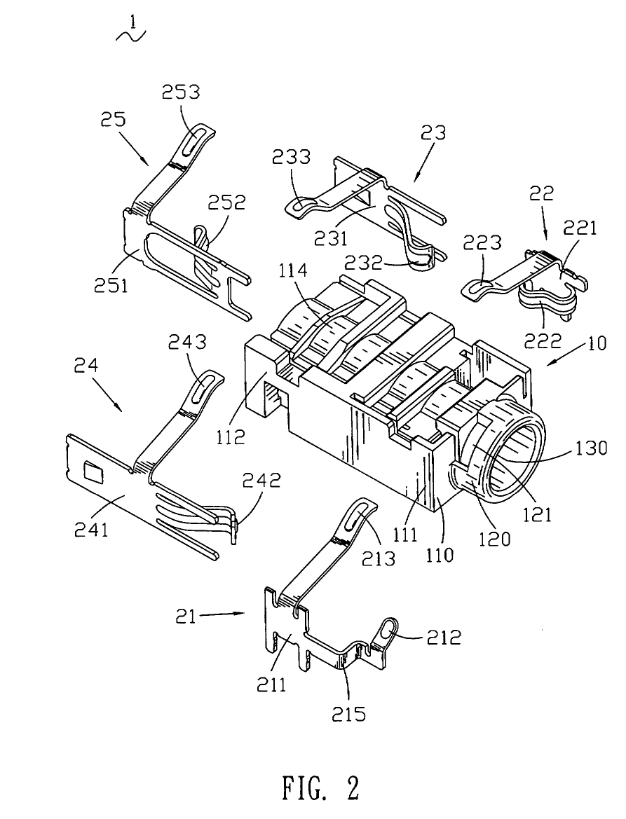

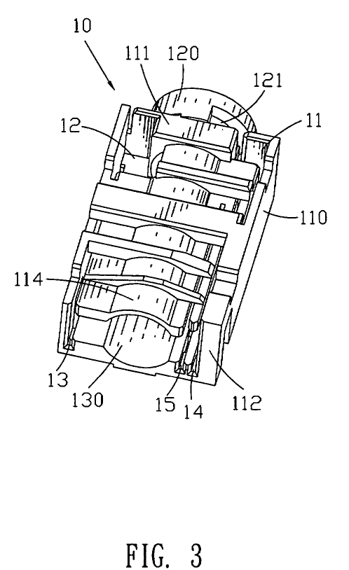

With reference to FIG. 2 and FIG. 3, the insulating body 10 includes a main body 110, which has a front portion 111, a rear portion 112 and a bottom wall 114. The insulating body 10 further has a mating portion 120 integrally formed at the front portion 111 of the main body 110. A mating hole 130 crosses through the mating portion 120 and extends into the main body 110. A first contact groove 11 is defined at one side edge of the front portion 111 of the main body 110, which is perpendicularly inwardly bended and extends forward to the joining portion between the main body 110 and the mating portion 120. The first contact groove 11 crosses through the front surface of the main body 110 to communicate with outside. The first contact groove 11 further crosses through the bottom wall 114 to communicate with outside. The mating portion 120 has an opening 121 defined therein. The opening 121 communicates the first contact groove 11 with the mating hole 130. A second contact groove 12 is defined at another side edge of the front portion 111 of the main body 110. The second contact groove 12 communicates with the mating hole in the main body 110 and crosses through the bottom wall 114 to communicate with outside. A third contact groove 13 is defined in one side of the rear portion 112 of the main body 110, which inwardly communicates with the mating hole 130 and partially crosses through the bottom wall 114 to communicate with outside. The insulating body 10 further has a fourth contact groove 14 and a fifth contact groove 15 collaterally defined in another side of the rear portion 112 of the main body 110. The fourth contact groove 14 communicates with the fifth contact groove 15 and further inwardly communicates with the mating hole 130. The fourth contact groove 14 and the fifth contact groove 15 partially cross through the bottom wall 114 to communicate with outside, respectively. Each of the third contact groove 13, the fourth contact groove 14, the fifth contact groove 15 and the mating hole 130 rearward crosses through the rear surface of the main body 110.

Please refer to FIG. 2 again. The first contact 21 has a holding part 211, a curving part 215 integrally formed at one side of the holding part 211, a touching part 212 integrally formed upon the free end of the curving part 215 and a compression part 213 integrally formed upon the top portion of the holding part 211. The curving part 215 perpendicularly inwardly bends and extends forward to the touching part 212. The second contact 22 has a holding part 221, a touching part 222 integrally formed at inside of the holding part 221 and a compression part 223 integrally formed upon the top portion of the holding part 221. The third contact 23 has a holding part 231, a middle portion of one side of the holding part 231 curving inward to form a touching part 232, and a compression part 233 integrally formed upon the top portion of the holding part 231. The fourth contact 24 has a holding part 241, a portion of one side of the holding part 241 being curved inward to form a touching part 242, and a compression part 243 integrally formed upon a middle portion of the top portion of the holding part 241. The fifth contact 25 has a holding part 251, a middle portion of the holding part 251 being curved inward to form a touching part 252, and a compression part 253 integrally formed upon one end of the top portion of the holding part 251. The holding part of each contact is arranged vertically, and the compression part of each contact is approximately perpendicular to the corresponding holding part. Furthermore, the touching part and the compression part of each contact are located at the same side of the corresponding holding part.

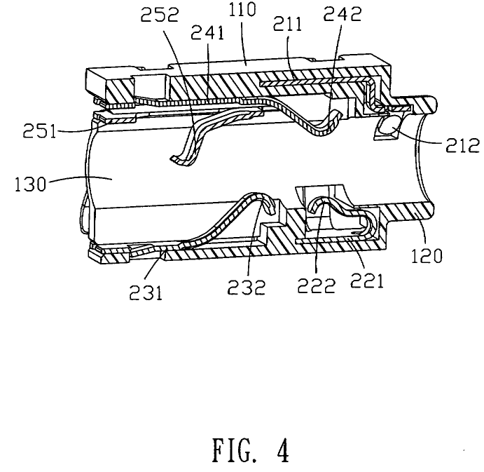

While be assembling, the first contact 21 is disposed in the insulating body 10 via the bottom wall 114 with the holding part 211 and the curving part 215 being held in the first contact groove 11 and the touching part 212 extending into the mating hole 130 of the mating portion 120 through the opening 121 of the mating portion 120. The second contact 22 is disposed in the insulating body 10 via the bottom wall 114 with the holding part 221 being held in the second contact groove 12 and the touching part 222 extending into the mating hole 130 through the main body 110. The third contact 23, the fourth contact 24 and the fifth contact 25 are inserted into the insulating body 10 from rear portion 112. The holding parts 231, 241 and 251 are respectively held in the third contact groove 13, the fourth contact groove 14 and the fifth contact groove 15. The touching parts 232, 242 and 252 extend into the mating hole 130 of the main body 110. With reference to FIG. 1, each of the compression parts 213, 223, 233, 243 and 253 of the contacts 21, 22, 23, 24 and 25 extend out along the bottom wall 114 of the insulating body 10, and are arranged in a specific order. Please refer to FIG. 4, which shows the arrangement of the touching parts 212, 222, 232, 243 and 252 in the mating hole 130.

As using, the compression parts 213, 223, 233, 243 and 253 of the audio jack connector 1 are connected with a circuit board (not shown). The mating hole 130 of the audio jack connector 1 mates with a matched audio plug connector (not shown) thereby transmitting audio signals between the audio plug connector and the circuit board.

As mentioned above, the first contact groove 11 is defined at one edge of the front portion of the main body 110, which extends to the joining portion between the main body 110 and the mating portion 120. Correspondingly, the holding part 211 and the curving part 215 are disposed in the first contact groove 11 along the edge of the main body 110. Furthermore, the mating portion 120 defines the opening 121 therein, through which the touching part 212 extends into the mating hole 130 of the mating portion 120. Therefore, the mating hole 130 of the main body 110 provides a wide-enough space to receive the touching parts 222, 232, 242 and 252 of the contacts 22, 23, 24 and 25. That is, unexpected touches among the touching parts of the contacts are reduced.

Although a preferred embodiment of the present invention has been described in detail hereinabove, it should be clearly understood that many variations and/or modifications of the basic inventive concepts herein taught which may appear to those skilled in the present art will fall within the spirit and scope of the present invention, as defined in the appended claims.

1. An audio jack connector, comprising:
an insulating body having a main body and a mating portion, the mating portion integrally formed at one end of the main body, a mating hole crossing through the mating portion and extending into the main body, a plurality of contact grooves being defined in the insulating body, each contact groove communicating with the mating hole and each contact groove communicating with outside; and
a plurality of contacts, each of the contacts has a holding part, a touching part and a compression part, the holding part of the contact being held in the contact groove, the compression part extending out the insulating body, the touching part extending into the mating hole;
wherein at least one of the contact grooves communicates with the mating hole through the mating portion, the touching part of the contact extends into the mating hole through the mating portion.

2. The audio jack connector as claimed in claim 1, wherein the touching part and the compression part of the contact are located at the same side corresponding to the holding part.

3. (canceled)

4. The audio jack connector as claimed in claim 1, wherein the mating portion further comprises an opening therein, which communicates the contact groove with the mating hole.

5. The audio jack connector as claimed in claim 4, wherein the contact further comprises a curving part formed at one side of the holding part thereof, in which the touching part of the contact is formed upon the free end of the curving part, and the touching part of the contact extends into the mating hole through the opening of the mating portion, further the curving part perpendicularly inwardly bends and extends forward to the touching part.
